(19) United States
(12) Patent Application Publication
(10) Pub. No.: US 2026/0070747 A1
(43) Pub. Date: Mar. 12, 2026

(54) CONVEYING AND DRYING SYSTEMS FOR GRANULATED MATERIALS

(71) Applicant: Novatec, Inc., Baltimore, MD (US)

(72) Inventors: Conrad BESSEMER, Millersville, MD (US); Frederick W. EICHHORN, II, Finksburg, MD (US); Gregory Michael WASHBURN, Bridgeville, DE (US); Ryan ISMIRLIAN, Glen Burnie, MD (US); Mark HAYNIE, Pasadena, MD (US)

(73) Assignee: Novatec, Inc., Baltimore, MD (US)

(21) Appl. No.: 19/189,821

(22) Filed: Apr. 25, 2025

Related U.S. Application Data
(60) Provisional application No. 63/638,576, filed on Apr. 25, 2024.

(51) Int. Cl. B65G 53/66; B65G 53/40; B65G 53/60; G01M 13/045

(52) U.S. Cl. CPC B65G 53/66; B65G 53/40; B65G 53/60; G01M 13/045; B65G 2201/042

(57) ABSTRACT

Systems for conveying granulated materials from a material source include a receiver in fluid communication with a material source, a vacuum generator or a pump unit having a blower configured to generate a vacuum or a pressurized airflow that transports the granulated material to the receiver from the material source, and a combination relief and break valve located in the flow path between the blower and the receiver. The valve is configured to interrupt the vacuum or the pressurized airflow provided to the receiver when the vacuum level or the positive pressure level reaches a relief set point. An electronic control unit of the system is configured to automatically adjust the relief set point based on one or more predetermined criteria. The vacuum generator or the pump unit can include an IPM-SynRM motor, IPMSM motor, or a PMSM motor that drives the blower of the impeller in rotation.

### CROSS-REFERENCE TO RELATED APPLICATIONS

This application claims the benefit under 35 U.S.C. § 119(e) to U.S. provisional application No. 63/638,576, filed Apr. 25, 2024, the contents of which are incorporated by reference herein in their entirety.

### BACKGROUND

Conventional conveying systems for granulated materials typically include a vacuum source or a pressure source connected to a receiver. The receiver, in turn, is connected to at least one material source, such as a surge hopper/bin, a storage silo, or a Gaylord container, so that the granulated material transported from the material source and into the receiver by the vacuum or pressure provided to the receiver. Upon reaching the receiver, the granulated material can be transferred to a processing device, such as an injection molding device that processes plastic resin granulates into plastic products. In other applications, the granulated material can be transferred from the receiver to a storage or shipping vessel.

The vacuum or pressure source typically comprises a blower, and an electric motor connected to the impeller of the blower and configured to drive the impeller in rotation. The motor may be a fixed-speed induction motor operated by simple motor starter. Alternatively, the motor can be controlled via a variable frequency drive (VFD) to provide a wider range of operational capability from one-hundred percent or full load rpm, down to about 30 Hz to about 33 Hz before running into cooling issues. While motors operated using VFDs have some favorable characteristics when applied to driving blowers, such as the ability to accelerate and decelerate in a controlled matter, a typical VFD-controlled motor cannot operate efficiently at speeds significantly above or below its nominal operating range, has a limited operational speed range, and can generate electrical harmonics during operation.

Some conveying systems are equipped with one or more relief valves configured to interrupt the vacuum or the (positively) pressurized flow when the vacuum level or the positive pressure level approaches an excessive value. The relief valve is adjusted to a predetermined safe operational maximum load that, when reached, causes the relief valve to open and allow ambient air or air from another source to enter the vacuum or pressure line so as to relieve, or lower the vacuum level or the positive pressure level, thereby preventing the equipment damage and safety hazards that could occur if the vacuum or pressure level reaches excessive levels. The relief valve may be configured such that the relief is adjustable so as to account for various factors, such as the local barometric pressure, that may affect the desired set point. The set point usually is set and adjusted manually at the factory/manufacturer for the specific application/location in which the valve is to be used, to account for factors such as the local elevation, the type of pump being used, etc.

Drying systems for granulated materials also incorporate conventional induction motors. For example, some drying systems include one or more heater/blower units that heat dry process air and circulate the process air through a drying hopper in which the granulated material resides, so that the heated air can remove moisture from the granulated material. The heater/blower unit can help to optimize the operation of the associated drying hopper with respect to power consumption or drying performance, or by matching the drying rate so as to correspond to the moisture loading of the granulate material in systems equipped with a moisture sensing probe, to reduce the overall energy input needed for the drying process.

Many drying systems also include a dryer that receives the process air from the drying hopper after the process air has absorbed the moisture from the granular material. The dryer may include a desiccant material that absorbs the moisture from the process air, and a blower that recirculates the dried process air to the heater/blower unit (if the system is so equipped) so that the process air is again heated and circulated to the interior of the drying hopper.

The dryer may incorporate a combination heater and booster blower that provides heated air to regenerate the desiccant material once the desiccant material has become saturated with the moisture it has absorbed from the process air. Alternatively, the heated air can be provided to the dryer by a heater, and a blower located remotely from the heater.

The blowers in heater/blower units and dryers typically incorporate fixed-speed induction motors, or induction motors controlled by VFDs. The use of these types of motors in drying systems can present the present disadvantages similar to those discussed above in relation to conveying systems.

### SUMMARY

In one aspect, the disclosed technology relates to integrating Internal/Interior Permanent Magnet Synchronous Motors (“IPMSM motors”), Permanent Magnet Synchronous Motors (“PMSM motors”), and Internal/Interior Permanent Magnet Synchronous Reluctance Motors (“IPM-SynRM motors”) into vacuum/pressure conveying systems and related industrial applications such as air blowing for drying and pressure/vacuum cleaning processes. It is believed that the disclosed technology, by facilitating the enhanced performance and energy efficiency afforded by IPMSM, PMSM, and IPM-SynRM motor technologies, can result in advantages in operational efficiency, energy conservation, and reduced maintenance overhead in the conveying and processing of granulated materials.

In another aspect of the disclosed technology, a system for conveying a granulated material from at least one material source includes at least one receiver in fluid communication with the material source, and at least one vacuum generator or pump unit having a blower configured to generate a vacuum or a pressurized airflow, a motor, and a control unit communicatively coupled to the motor. The blower is in fluid communication with the receiver, and includes a housing, and an impeller mounted in the housing and configured to rotate in relation to the housing. The motor is connected to the blower and is configured to generate a torque that drives the impeller in rotation, and the motor is one of an IPM-SynRM motor, an IPMSM motor, and a PMSM motor. The control unit is configured to control the speed of the motor based on inputs from one of more sensors of the system.

In another aspect of the disclosed technology, a system for conveying a granulated material from at least one material source includes at least one receiver in fluid communication with the material source, and at least one vacuum generator or pump unit having a blower configured to generate a vacuum or a pressurized airflow, a combination relief and break valve in fluid communication with the blower, and a control unit communicatively coupled to the combination relief and break valve. The blower is in fluid communication with the receiver on a selective basis so that an interior volume of the receiver is subjected to the vacuum or the pressurized airflow and the granulated material is transported to the interior volume of the receiver from the material source in response to the vacuum or the pressurized airflow. The combination relief and break valve is configured to interrupt the vacuum or the pressurized airflow provided to the interior volume of the receiver when a vacuum level or a pressure level of the pressurized airflow reaches a relief set point. The control unit is configured to adjust the relief set point based on one or more predetermined criteria.

In another aspect of the disclosed technology, the blower includes a housing, and an impeller mounted in the housing and configured to rotate in relation to the housing. The vacuum generator or the pump unit further includes a motor connected to the blower and configured to generate a torque that drives the impeller in rotation.

In another aspect of the disclosed technology, the motor is one of an IPM-SynRM motor, an IPMSM motor, and a PMSM motor.

In another aspect of the disclosed technology, the one or more predetermined criteria include a local barometric pressure.

In another aspect of the disclosed technology, the control unit is further configured to alter the relief set point based on a pre-determined relationship between a desired relief set point and the local barometric pressure.

In another aspect of the disclosed technology, the control unit is further configured to increase or decrease the relief set point and increase or decrease a rotational speed of the impeller in response to a change in a vacuum level or a positive pressure level in a material flow path between the material source and the vacuum receiver or the pump unit.

In another aspect of the disclosed technology, the control unit includes a processor, a memory communicatively coupled to the processor, and computer-executable instructions stored on the memory. The processor, upon executing the computer-executable instructions, is configured to cause the relief set point to change based on the one or more predetermined criteria.

In another aspect of the disclosed technology, the combination relief and break valve includes a housing defining: an interior passage in fluid communication with the blower, a first opening adjoining the interior passage and being in fluid communication with the receiver on a selective basis, and a second opening adjoining the interior passage and being in fluid communication with the ambient environment on a selective basis. The combination relief and break valve also includes a sealing member configured to move between a first position at which the sealing member closes the second opening, and a second position at which the sealing member closes the first opening.

In another aspect of the disclosed technology, the combination relief and break valve further includes an actuator configured to move the sealing member between the first and second positions.

In another aspect of the disclosed technology, the actuator, in response to an input from the control unit, is configured to vary a force with which the sealing member is held in the first position of the sealing member to vary the relief set point.

In another aspect of the disclosed technology, the actuator includes a cylinder, and a piston disposed within the cylinder and connected to the sealing member. The is configured to move within the cylinder between a first position at which the piston constrains the sealing member in the first position of the sealing member, and a second position at which the piston constrains the sealing member in the second position of the sealing member. The actuator also includes a solenoid valve configured to direct compressed air to the first and second sides of the piston on a selective basis, and an air regulator coupled to the solenoid valve and communicatively coupled to the control unit. The air regulator is configured to cause the solenoid valve to direct compressed air to the first side of the piston to maintain the piston in the first position of the piston and thereby allow the vacuum be transmitted to the receiver by way of the first opening in the housing.

In another aspect of the disclosed technology, the relief set point is proportional to the air pressure on the first side of the piston.

In another aspect of the disclosed technology, the control unit is further configured to generate an output that, when received by the combination relief and break valve, causes the sealing member to move to and remain in the second position of the sealing member when the blower is operated at an idle condition.

In another aspect of the disclosed technology, the actuator includes a cylinder, and a piston disposed within the cylinder and connected to the sealing member. The piston is configured to move within the cylinder between a first position at which the piston constrains the sealing member in the first position of the sealing member, and a second position at which the piston constrains the sealing member in the second position of the sealing member. The actuator also includes a solenoid valve configured to direct compressed air to the first and second sides of the piston on a selective basis, and an air regulator coupled to the solenoid valve and communicatively coupled to the control unit. The air regulator is configured to cause the solenoid valve to direct compressed air to the second side of the piston to cause the sealing member to move to and remain in the second position of the sealing member when the pressure level of the pressurized airflow reaches the relief set point or when the blower is operated at an idle condition.

In another aspect of the disclosed technology, the system further includes a direct drive jaw hub connection coupled to the motor and the blower and configured to transfer the torque between the motor and the blower.

In another aspect of the disclosed technology, the system further includes a pressure sensor communicatively coupled to the control unit and configured to sense a vacuum level or a positive pressure level within the combination relief and break valve upstream of the blower.

In another aspect of the disclosed technology, the control unit is further configured to adjust the performance of the vacuum generator or the pump unit based on the type of material feed used to provide the granulated material to the system, and the vacuum level or the positive pressure level within the combination relief and break valve upstream or downstream of the blower.

In another aspect of the disclosed technology, the control unit is further configured to generate an alert and/or an alarm upon detecting one or more of an underloaded condition, an overloaded condition, a vacuum leak, a deadheaded condition, and an empty material source condition based on the vacuum level or the positive pressure level within the combination relief and break valve upstream or downstream of the blower.

In another aspect of the disclosed technology, the system further includes one or more vibration sensors communicatively coupled to the control unit and configured to sense vibration levels in the blower and the motor. The control unit is further configured to determine a status of the oil and a status of one or more bearings of the blower and/or the motor based on the vibration levels.

In another aspect of the disclosed technology, the control unit is further configured to cause the blower to operate at a full speed; a normal speed less than the full speed; a slow speed less than the normal speed; and a speed adapted to a particular line size between the material source and the vacuum receiver or the pump unit.

In another aspect of the disclosed technology, the granulated material is one or more of plastic resin granulates, an agricultural grain, a food product or food ingredient, and a chemical product or chemical ingredient.

In another aspect of the disclosed technology, the vacuum generator or the pump unit further includes a filter configured to filter the air passing through the vacuum generator or the pump unit, and the control unit is further configured to increase a speed of the motor in response to an increase in a pressure drop across the filter to clear the filter.

In another aspect of the disclosed technology, a vacuum generator includes a blower configured to generate a vacuum, and a motor. The blower includes a housing, and an impeller mounted in the housing and configured to rotate in relation to the housing. The motor is connected to the blower and is configured to generate a torque that drives the impeller in rotation, and the motor is one of an IPM-SynRM motor, an IPMSM motor, and a PMSM motor.

In another aspect of the disclosed technology, the motor includes an outer casing, a rotor mounted within the outer casing and having an iron core and a plurality of electromagnets embedded within the core, and a winding mounted on the outer casing and surrounding the core. The rotor is configured to rotate in relation to the outer casing and is configured to generate the torque based on an electromotive force generated by an alternating current provided to the winding, and magnetic fields generated by the permanent magnets.

In another aspect of the disclosed technology, the vacuum generator further includes a combination relief and break valve in fluid communication with the blower, and a control unit communicatively coupled to the combination relief and break valve. The vacuum generator is configured to be fluidly coupled to an upstream component so that the upstream component is subjected to the vacuum produced by the blower on a selective basis. The combination relief and break valve is configured to interrupt the vacuum provided to the upstream component when the vacuum level within the combination relief and break valve reaches a relief set point. The control unit is configured to adjust the relief set point based on one or more predetermined criteria.

In another aspect of the disclosed technology, a pump unit includes a blower configured to generate a pressurized airflow, and a motor. The blower includes a housing, and an impeller mounted in the housing and configured to rotate in relation to the housing. The motor is connected to the blower and is configured to generate a torque that drives the impeller in rotation, and the motor is one of an IPM-SynRM motor, an IPMSM motor, and a PMSM motor.

In another aspect of the disclosed technology, the motor includes an outer casing, a rotor mounted within the outer casing and having an iron core and a plurality of electromagnets embedded within the core. The motor also includes a winding mounted on the outer casing and surrounding the core. The rotor is configured to rotate in relation to the outer casing and is configured to generate the torque based on an electromotive force generated by an alternating current provided to the winding, and magnetic fields generated by the permanent magnets.

In another aspect of the disclosed technology, the vacuum generator further includes a combination relief and break valve in fluid communication with the blower, and a control unit communicatively coupled to the combination relief and break valve. The pump unit is configured to be fluidly coupled to a downstream component so that the downstream component is subjected to the pressurized airflow by the blower on a selective basis. The combination relief and break valve is configured to interrupt the pressurized airflow to the upstream component when the pressure level of the pressurized airflow within the combination relief and break valve reaches a relief set point. The control unit is configured to adjust the relief set point based on one or more predetermined criteria.

In another aspect of the disclosed technology, a system for drying a granulated material includes at least one drying hopper defining an internal volume configured to hold the granulated material while dried and heated process air is directed over the granulated material to remove moisture from the granulated material. The system also includes at least one heater configured to heat the process air, and a first blower configured to circulate the process air within the drying hopper. The first blower includes a housing, and an impeller mounted in the housing and configured to rotate in relation to the housing. The system also includes a first motor that drives the impeller in rotation. The first motor is one of an IPM-SynRM motor, an IPMSM motor, and a PMSM motor.

In another aspect of the disclosed technology, the system further includes a dryer in fluid communication with the heater/blower unit. The dryer includes a desiccant material configured to remove moisture from the process air, and a second blower configured to circulate the process air over or through the desiccant. The second blower has a housing, and an impeller mounted in the housing and configured to rotate in relation to the housing. The dryer also includes a second motor connected to the second blower and configured to generate a torque that drives the impeller of the second blower in rotation. The second motor is one of an IPM-SynRM motor, an IPMSM motor, and a PMSM motor.

In another aspect of the disclosed technology, a system for conveying a granulated material from at least one material source to a receiving area includes at least one vacuum generator in fluid communication with the receiving area and having a blower configured to generate a vacuum, and a control unit. The blower incudes a housing, and an impeller mounted in the housing and configured to rotate in relation to the housing. The vacuum generator also includes a motor connected to the blower and communicatively coupled to the control unit. The motor is configured to drive the impeller in rotation. The motor is one of an IPM-SynRM motor, an IPMSM motor, and a PMSM motor. The vacuum generator further includes a control unit configured to adjust operational parameters of the system in real-time to optimize energy usage and performance of the system.

In another aspect of the disclosed technology, the granulated material is one or more of plastic resin granulates, an agricultural grain, a food product or food ingredient, and a chemical product or chemical ingredient.

In another aspect of the disclosed technology, a system for conveying a granulated material from at least one material source to a receiving area includes at least one pump unit in fluid communication with the receiving area and including a blower configured to generate a pressurized airflow, a motor, and a control unit communicatively coupled to the blower. The blower incudes a housing, and an impeller mounted in the housing and configured to rotate in relation to the housing. The motor is coupled to the impeller and is configured to drive the impeller in rotation. The motor is one of an IPM-SynRM motor, an IPMSM motor, and a PMSM motor, the control unit is configured to control the speed of the motor based on inputs from one of more sensors of the system. The system also includes a material pick-up device in fluid communication with the blower and configured to introduce the granulated material into the pressurized airflow.

In another aspect of the disclosed technology, the system further includes a material feed metering device configured to meter the granulated material into the pressurized airflow.

In another aspect of the disclosed technology, system for drying a granulated material includes at least one vacuum generator having a blower configured to generate a vacuum, and a control unit. The blower includes a housing, and an impeller mounted in the housing and configured to rotate in relation to the housing. The system also includes a motor connected to the blower and communicatively coupled to the control unit. The motor is configured to drive the impeller in rotation, and the motor being one of an IPM-SynRM motor, an IPMSM motor, and a PMSM motor. The control unit is configured to adjust operational parameters of the system in real-time to optimize energy usage and performance of the system.

In another aspect of the disclosed technology, the granulated material is one or more of plastic resin granulates, an agricultural grain, a food product or food ingredient, and a chemical product or chemical ingredient.

In another aspect of the disclosed technology, a system is provided for managing air flow in industrial applications, encompassing but not limited to drying, cleaning, and material handling, across various sectors including but not limited to energy production, pharmaceutical manufacturing, food processing, and chemical manufacturing. The system includes an advanced motor-driven blower, capable of generating both positive and negative air flow for diverse operational needs such as pressure flow cleaning in coal-fired energy plants, precision handling in pharmaceutical production, and moisture control in food processing. The system integrates a control unit configured for real-time adjustment of operational parameters to optimize energy usage, performance, and adaptability to variable industrial processes, ensuring precise control over air flow with multi-stage capabilities.

In another aspect of the disclosed technology, a method is provided for controlling air flow in industrial systems requiring precise air flow control and multi-stage operation, utilizing synchronous reluctance motors, including IPM-SynRM, for driving air blowers. The method includes steps for dynamically adjusting air flow based on real-time processing requirements across industries such as energy, pharmaceuticals, food, and chemicals. It emphasizes the system's ability to provide precise air flow control for processes like pressure cleaning in energy plants, drying in food and pharmaceutical manufacturing, and controlled environment maintenance in chemical processing. The control unit, integral to the system, ensures multi-level flow control, adapts to changes in environmental conditions such as barometric pressure, and maintains energy efficiency at varying operational speeds.

In another aspect of the disclosed technology, a system for conveying a granulated material from at least one material source includes at least one receiver in fluid communication with the material source, and at least one vacuum generator or pump unit having a blower configured to generate a vacuum or a pressurized airflow, a combination relief and break valve in fluid communication with the blower, and a control unit communicatively coupled to the combination relief and break valve. The blower is in fluid communication with the receiver on a selective basis so that an interior volume of the receiver is subjected to the vacuum or the pressurized airflow and the granulated material is transported to the interior volume of the receiver from the material source in response to the vacuum or the pressurized airflow. The combination relief and break valve is configured to interrupt the vacuum or the pressurized airflow provided to the interior volume of the receiver when a vacuum level or a pressure level of the pressurized airflow reaches a relief set point. The control unit is configured to adjust the relief set point based on one or more predetermined criteria to prevent and excessive vacuum or and excessive positive pressure within the system, and to vary a rotational speed of the blower to adjust the vacuum level or the positive pressure of the pressurized airflow within the system.

In another aspect of the disclosed technology, control unit is further configured to vary the rotational speed of the blower to finely adjust the vacuum level or the positive pressure of the pressurized airflow within the system.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a diagrammatic view of a system for conveying a granulated material;

FIG. 2 is a top-side perspective view of a blower unit, in the form of a vacuum generator, of the system shown in FIG. 1;

FIG. 3 is a side view of the vacuum generator shown in FIG. 2;

FIG. 4 is a another side view of the vacuum generator shown in FIGS. 2 and 3, from a perspective rotated by about 180° from the perspective of FIG. 3;

FIG. 5A is a cross-sectional view of a combination relief and break valve of the vacuum generator shown in FIGS. 2-4, taken through the line V-V of FIG. 2 and showing a sealing puck of the valve in an upper position;

FIG. 5B is a cross-sectional view of a combination relief and break valve of the vacuum generator shown in FIGS. 2-5A, taken through the line V-V of FIG. 2 and showing the sealing puck in a lower position;

FIG. 6 is a diagrammatic view of various electrical and electronic components of the vacuum generator shown in FIGS. 2-5B;

FIG. 6A is a diagrammatic view of various electrical and electronic components of a muti-station conveying system incorporating the vacuum generator shown in FIGS. 2-6;

FIG. 7 is a diagrammatic view of a blower, a direct drive jaw hub connection, and an IPM-SynRM motor of the vacuum generator shown in FIGS. 2-6;

FIG. 8 is a perspective view of the motor shown in FIG. 7;

FIG. 9 is a diagrammatic view of a multi-station system for conveying a granulated material;

FIG. 10 is a diagrammatic view of a multi-station system for drying a granulated material;

FIG. 11A is a schematic side view of one station of the a multi-station drying system shown in FIG. 10;

FIG. 11B is an isometric view the drying station shown in FIG. 11A;

FIG. 12 is a schematic view of a single-station system for drying a granulated material; and

FIG. 13 is a diagrammatic view of a pressurized system for conveying a granulated material.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

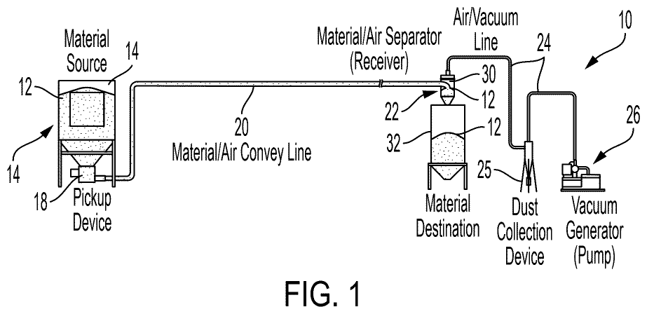

FIG. 1 depicts a single-station pneumatic conveying system 10. The conveying system 10 is configured to convey granulates, i.e., a granulated material. The granulated material can be, for example, plastic resin granulates 12 used to make plastic articles. The resin granulates 12 initially are located in a material source, such as a surge hopper/bin 14. In the alternative, the material source can be a silo, a Gaylord container, or another type of structure suitable for holding the resin granulates 12. The resin granulates 12 are held in an interior volume 16 of the surge hopper/bin 14. The terms “granulated materials” and “granulates,” as used herein, are intended to include, without limitation, pelletized materials, including reclaimed plastic resin in pelletized form; pharmaceutical products such as pills and capsules; agricultural grains; granulated food products and ingredients; granulated chemical products; powders; flaked materials; and any other granulated raw material used in plastics manufacturing, food production and processing, pharmaceutical and chemical manufacturing, agriculture, etc.

The direction of airflow through various components depicted in the figures is denoted by the arrows 101.

The system 10 also includes a material pickup device 18 located at the exit of the surge hopper/bin 14. The material pickup device 18 can be, for example, an automated material feed. Other types of pickup devices, such as a carbureted probe/lance, a vacuum take-off box, a purge-capable box, etc. can be used in the alternative, depending on the configuration of the material source used in a particular application.

The use of the system 10 to convey resin granulates 12 is disclosed for illustrative purposes only. The system 10 and variants thereof can be used to convey other types of granulated materials, and the capabilities of the system 10 make it beneficial for use in a range of industrial applications beyond conveying and drying granulated materials. For example, in the pharmaceutical industry, the system 10 and variants thereof can help provide precise handling and processing of granular drug formulations, critical for maintaining dosage accuracy and product integrity. In food processing, the efficiency and control provided by the system 10 and variants thereof can help enable optimal handling of granulated ingredients, preserving quality while maximizing throughput. The use of the system 10 and variants thereof also can provide benefits in chemical-manufacturing, which demands strict control over material conveyance to ensure safety and product purity. The system 10 and variants thereof also can be used to convey agricultural grains.

The system 10 is a vacuum conveying system. The disclosed technology can be applied to pressurized conveying systems, and unless otherwise noted, the following inventive concepts described in relation to the vacuum conveying system 10 can be adapted and applied to pressurized conveying systems, such as the pressure conveying system 300 described below.

The system 10 includes a receiver in the form of a vacuum receiver 22, an air/vacuum line 24, a dust collection device 25, and a vacuum generator 26. The material/air convey line 20 is connected to the material pickup device 18 and the vacuum receiver 22. The air/vacuum line 24 is connected to the vacuum receiver 22 and the vacuum generator 26. The material/air convey line 20 conveys the resin granulates 12 from the interior volume 16 of the surge hopper/bin 14 and to an interior volume 30 of the vacuum receiver 22. The vacuum generator 26 creates the negative pressure or vacuum required to pull the resin granulates 12 through the material/air convey line 20 and into the vacuum receiver 22. The vacuum is provided to the vacuum receiver 22 by way of the air/vacuum line 24. The dust collection device 25 is located in the flow path defined by the air/vacuum line 24, and removes dust and other airborne contaminates from the air being drawn into the vacuum generator 26.

The resin granulates 12, upon entering the interior volume 30 of the vacuum receiver 22, drop toward the bottom of the interior volume 30 due to gravity. The vacuum receiver 22 includes a gate valve (not shown) or other suitable device for covering an exit of the interior volume 30 so that the resin granulates 12 can be held in the interior volume 30 and released on a selective basis.

The vacuum receiver 22 is located above a material destination in the form of a holding bin 32. After the vacuum receiver 22 has been loaded and no longer is being subjected to a vacuum, the resin granulates 12 can be provided to the holding bin 32 by opening the gate valve on the vacuum receiver 22, so that the resin granulates 12 can drop into the holding bin 32 due to gravity. The holding bin 32 can be located above a process device (not shown) that receives the resin granulates 12 from the holding bin 32. The process device can be, for example, as an injection molding machine configured to form plastic articles from the resin granulates 12.

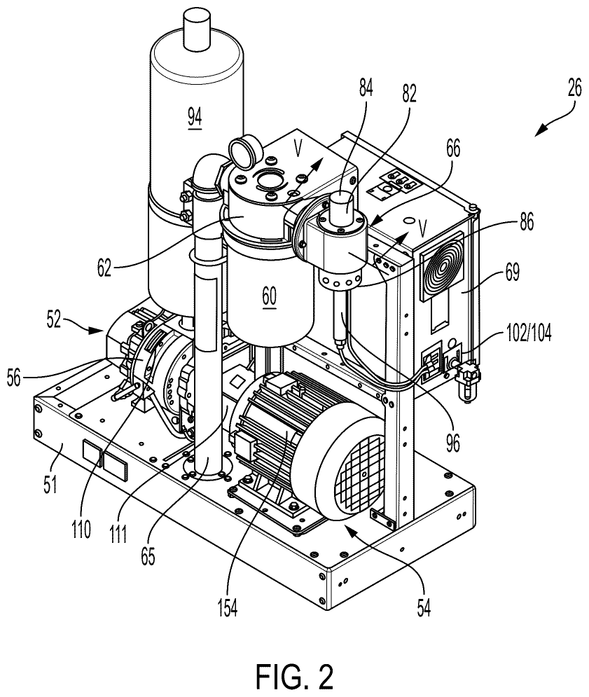

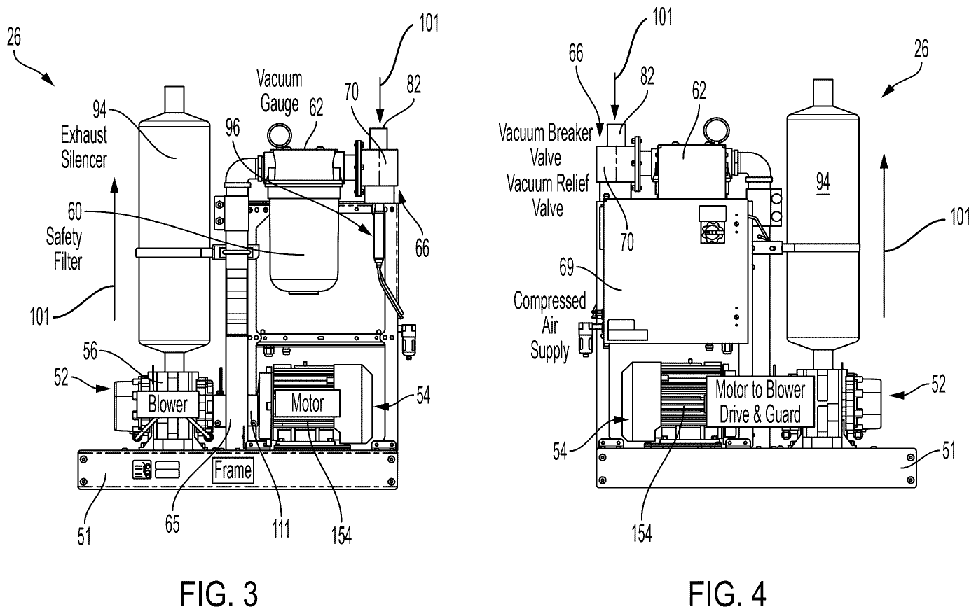

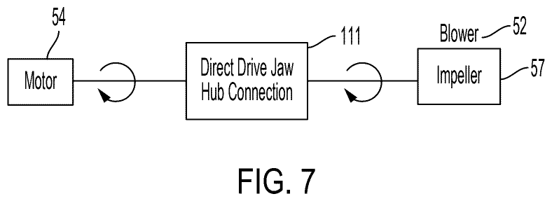

Referring to FIGS. 2-5, the vacuum generator 26 comprises a frame 51, a blower 52, and a motor 54. The blower 52 and the motor 54 are mounted on the frame 51. The blower 52 includes a stationary housing 56, and an impeller 57 mounted within the housing 56 and configured to rotate in relation to the housing 56. The impeller 57 is depicted diagrammatically in FIG. 7. The rotating impeller 57 draws air through a suction opening the housing 56 and discharges the air through a discharge opening in the housing 56, generating a negative pressure at the suction opening.

The impeller 57 is driven in rotation by the motor 54. The motor 54 can be an IPM-SynRM motor. In alternative embodiments, the motor 54 can be an IPMSM motor or a PMSM motor. These types of motors are characterized by their ability to provide immediate torque response, operate efficiently across a wide range of speeds significantly above or below their nominal speed, and maintain high power density within compact designs. These characteristics can allow the system 10 to adapt dynamically to varying operational demands in real-time, leveraging the rapid acceleration and deceleration capabilities of the motor 54 for optimal performance. In comparison to a conventional induction motor equipped with a motor starter and overload protection, IPM-SynRM, IPMSM, and PMSM motors typically have a higher power density, allowing these types of motors to produce greater power within a smaller frame. Also, the torque output of IPM-SynRM, IPMSM, and PMSM motors is instantaneous, which can provide the vacuum generator 26 with favorable startup and acceleration characteristics. In addition, these types of motors currently fall within the ICE (International Electrotechnical Commission) IE4 and IE5 efficiency classes, which are higher than the current industry standard, i.e., the IE3 efficiency class. Moreover, IPM-SynRM, IPMSM, and PMSM motors can operate efficiently at speeds substantially above and below their nominal range of operating speeds.

Also, the speed of an induction motor is a function of the frequency of the power supply. For example, an induction motor with a 50 Hz power supply will turn at five sixths (50/60) of the speed and will develop five-sixths of the air flow of a comparable motor operated with a 60 Hz power supply. An IPM-SynRM, IPMSM, and PMSM motor, by contrast, can be operated above its nominal operating range to compensate for such differences in the power supply and thereby by maintain optimal performance of the system 10.

In the case of multi-stage blower systems, synchronized reluctance motors can optimize the power use and performance of a blower/motor combination so that each stage of the multi-stage system operates at an optimal speed. This may not be possible with an induction motor because, at low speeds, the blower may not cool itself properly, which can lead to component wear and degradation, such as decreased bearing life; and at higher speeds, the induction motor is not capable of compensating for an off-design power supply, e.g., 50-Hz in lieu of 60-Hz. Also, operating an induction motor at speeds below its nominal speed range can adversely affect the power factor of the facility in which the motor is installed.

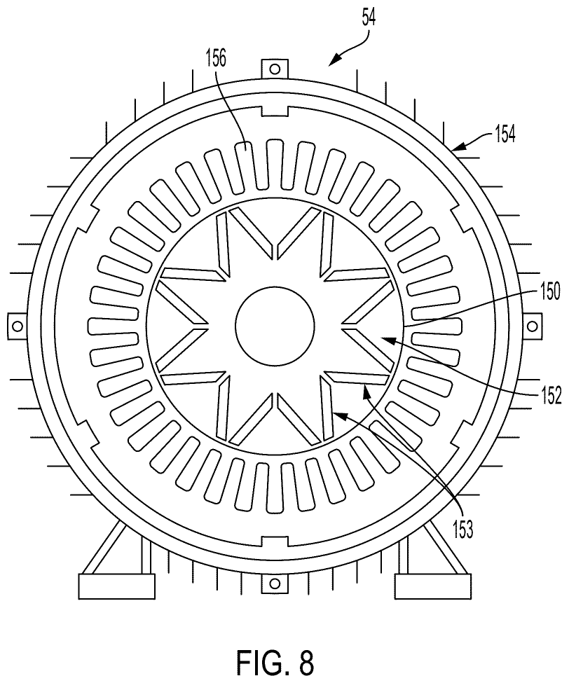

Referring to FIG. 8, the motor 54 can include a rotor 150 comprising an iron core 152, and a plurality of permanent magnets 153 embedded in the core 152. The motor 54 also includes an outer casing 154, and a winding 156 mounted on the outer casing 154 and surrounding the rotor 150. The rotor 150 is mounted inside the outer casing 154, and is configured to rotate in relation to the outer casing 154 and the winding 156. The electromotive force generated by alternating current provided to the winding 156, in conjunction with the magnetic fields generated by the permanent magnets 153, create a torque on the shaft of the rotor 150. This torque is transmitted to and drives and the impeller 57 of the blower 52.

In alternative embodiments, the motor 54 can be a type of motor other than an IPM-SynRM, IPMSM, or PMSM motor.

The vacuum generator 26 also includes a direct drive jaw hub connection 111 that transfers torque generated by the motor 54 to the impeller 57 of the blower 52. The direct drive jaw hub connection 111 is depicted diagrammatically in FIG. 7. The direct drive jaw hub connection 111 is lighter, quieter, and more compact than a conventional sheave and belt drive of comparable capacity. Torque can be transferred from the motor 54 to the impeller 57 of the blower 52 by devices of than the direct drive jaw hub connection 111 in alternative embodiments. For example, alternative embodiments of the system 10 can include belt/chain drives, especially in applications that require impeller speeds greater than those that can be provided directly by the motor 54. In other alternative embodiments, a geared drive can be used in lieu of the direct drive jaw hub connection 111.

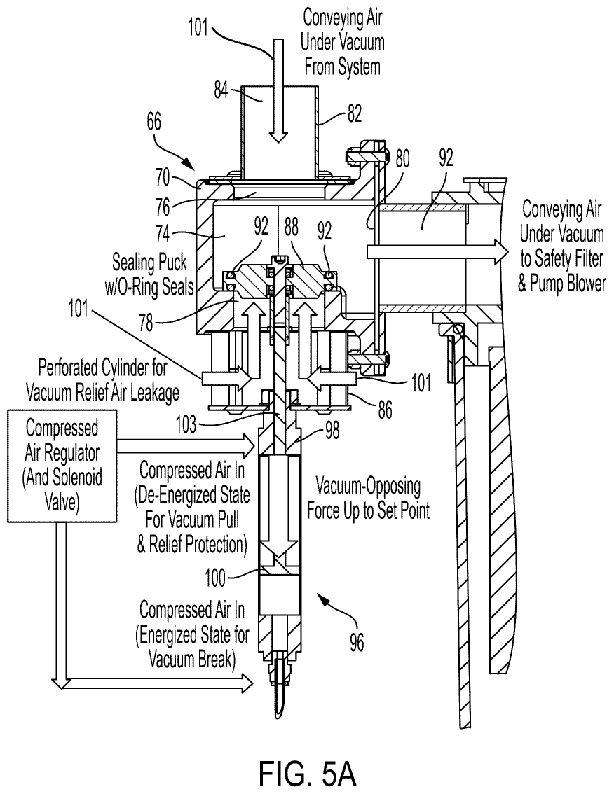

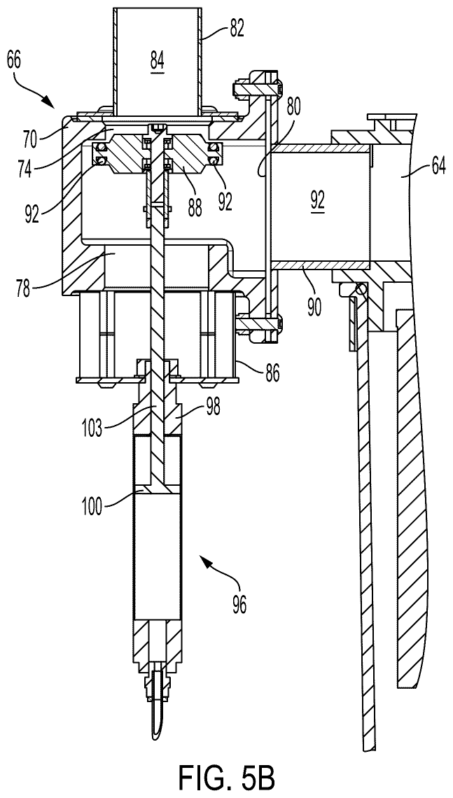

The vacuum generator 26 also includes an air filter 60 mounted on a filter housing 62. The air filter 60 and an adjoining internal air passage 64 of the filter housing 62 are in fluid communication with the suction opening of the blower 52 by way of an air/vacuum line 65 of the vacuum generator 26. Thus, the vacuum generated by the blower 52 is transmitted to the air filter 60 and the internal air passage 64 of the filter housing 62 by way of the air/vacuum line 65. The internal air passage 64 is visible, in part, in FIGS. 5A and 5B.

The vacuum generator 26 further includes a combination relief and break valve 66, and an electronic control in the form of a conveying control 68 communicatively coupled to the valve 66.

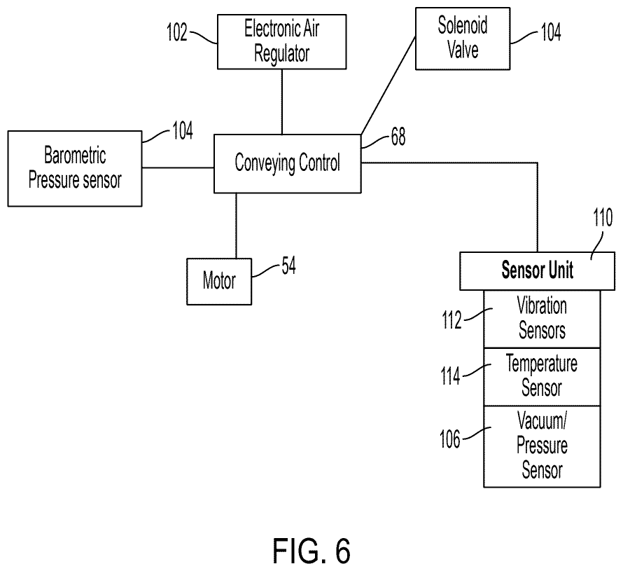

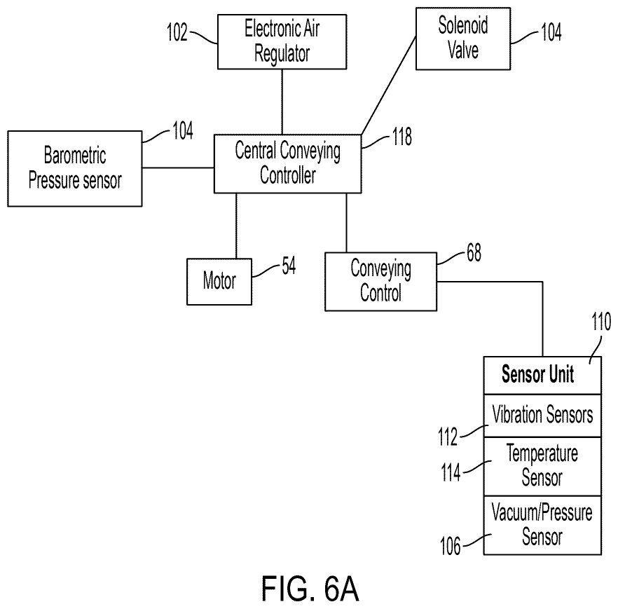

The conveying control 68 is depicted diagrammatically in FIG. 6, and can be housed within a service panel 69 of the vacuum generator 26. The conveying control 68 is configured to perform the various control functions described below. In alternative embodiments of the system 10, the control functions can be divided between and performed by more than one electronic control.

The conveying control 68 comprises a processor, such as a microprocessor; an internal bus; a memory communicatively coupled to the processor via the bus; computer-executable instructions stored in the memory; and an input-output interface communicatively coupled to the internal bus. The conveying control 68 can have other configurations in alternative embodiments. Also, the conveying control 68 can include additional components, a description of which is not necessary to an understanding of the disclosed technology. In multi-station systems, such as those described below, the conveying control 68 can be communicatively coupled to a central conveying controller 118 of the multi-station system, as depicted diagrammatically in FIG. 6A.

The combination relief and break valve 66 is configured to relieve the vacuum provided to the air/vacuum line 24 (and the vacuum receiver 22) at a set point that can be set and varied electronically by the conveying control 68. The valve 66 also is configured to interrupt, or break the vacuum when, for example, the blower 52 is being operated at an idle state.

The valve 66 is mounted on the filter housing 62, and is connected to the air/vacuum line 24. The valve 66 comprises a body 70. Referring to FIGS. 5A and 5B, the body 70 defines an internal volume 74. The body 70 also defines a first opening 76, a second opening 78, and a third opening 80 that each adjoin the internal volume 74. The body 70 is connected to the filter housing 62 by way of an outlet fitting 90. The outlet fitting 90 defines an interior passage 92 that aligns with the third opening 80 in the body 70 and the internal passage 64 of the filter housing 62, so that the valve 66 is in fluid communication with the filter housing 62 by way of the outlet fitting 90.

Referring still to FIGS. 5A and 5B, the valve 66 is connected to, and is in fluid communication with the air/vacuum line 24 by way of an inlet fitting 82. The inlet fitting 82 defines an interior passage 84. The inlet fitting 82 is connected an upper portion of body 70 so that the interior passage 84 aligns with the first opening 76 in the body 70, placing the valve 66 in in fluid communication with the air/vacuum line 24 by way of the inlet fitting 82.

Thus, the vacuum generated by the blower 52 is transmitted to the interior volume 30 of the vacuum receiver 22 by way of the air filter 60, the filter housing 62, the outlet fitting 90, the valve 66, the inlet fitting 82, and the air/vacuum line 24. The vacuum subsequently is transmitted from the interior volume 30 of the vacuum receiver 22 and to the interior volume 16 of the surge hopper/bin 14 by way of the material/air convey line 20, which in turn causes the resin granulates 12 to be drawn from the surge hopper/bin 14 and to the vacuum receiver 22 as discussed above.

The valve 66 further comprises a secondary inlet 86. The secondary inlet 86 is connected a lower portion of body 70 so that the internal volume 74 of the body 70 can fluidly communicate with the ambient environment by way of the second opening 78 on a selective basis, such as during vacuum break or pump-idle operation as discussed below. The secondary inlet 86 can be, for example, a perforated cylinder that facilitates the passage of air therethrough while reducing the overall sound generation caused by the air rushing into the internal volume 74.

As shown in FIGS. 5A and 5B, the valve 66 also includes a sealing member in the form of a sealing puck 88. The sealing puck 88 is movable between a first, or lower position shown in FIG. 5A, and a second, or upper position shown in FIG. 5B. The lower position corresponds to a de-energized state of the valve 66, and the upper position corresponds to an energized state of the valve 66. As can be seen in FIG. 5A, when in the lower position, the sealing puck 88 covers the second opening 78 of the body 70. The sealing puck 88 covers the first opening 76 of the body 70 when the sealing puck 88 is in the upper position. The sealing puck 88 has O-ring seals 92, or other types of sealing surfaces, that form seals between the sealing puck 88 and the adjacent surfaces of the body 70 when the sealing puck 88 is in the upper and lower positions.

Thus, when the sealing puck 88 is in the lower position as shown in FIG. 5A, the second opening 78 in the body 70 is blocked and sealed. Air from the interior volume 30 of the vacuum receiver 22 is drawn into the internal volume 74 of the body 70 by way of the air/vacuum line 24, the interior passage 84 of the inlet fitting 82, and the first opening 76 of the body 70 in response to the vacuum generated by the blower 52. The resulting vacuum within the interior volume 30 of the vacuum receiver 22 is conveyed to the interior volume 16 of the surge hopper/bin 14, and to the material pickup device 18 located at the exit of the surge hopper/bin 14, by way of the material/air convey line 20, causing the resin granulates to be conveyed to the vacuum receiver 22 as discussed above. The air drawn into valve 66 from the air/vacuum line 24 exits the internal volume 74 of the body 70 by way of the third opening 80. The air then flows to the blower 52 by way of the outlet fitting 90, the filter housing 62, the air filter 60, and the air/vacuum line 65. The air subsequently is discharged to the ambient environment by way of an exhaust silencer 94 mounted on the blower 52.

When the sealing puck 88 is in the upper position as shown in FIG. 5B, the first opening 76 in the body 70 is blocked and sealed, and the vacuum generated by the blower 52 no longer is transmitted to the vacuum receiver 22, thereby relieving or breaking the vacuum within the vacuum receiver 22. Ambient air enters the internal volume 74 of the body 70 by way of the secondary inlet 86 and the second opening 78. The ambient air exits the internal volume 74 via the third opening 80, and is drawn into the blower 52 and discharged through the exhaust silencer 94 as discussed above.

The valve 66 also includes an actuator 96 configured to move the sealing puck 88 between its upper and lower positions. The actuator 96 is mounted on the secondary inlet 86, and can be configured, for example, as a double-acting pneumatic actuator. As shown in FIGS. 5A and 5B, the actuator 96 comprises a cylinder 98, a piston 100 positioned within the cylinder 98, and a rod 103 fixed to the piston 100.

The piston 100 is configured to translate linearly in relation to the cylinder 98 between a first position shown in FIG. 5A, and a second position shown in FIG. 5B. The linear movement of the piston 100 is transmitted to the sealing puck 88 by way of the rod 103. When in its first position, the piston 100 positions the sealing puck 88 in the lower position of the sealing puck 88. When in its second position, the piston 100 positions the sealing puck 88 in the upper position of the sealing puck 88.

The vacuum generator 26 further comprises an electronic air regulator 102 communicatively coupled to the conveying control 68. The vacuum generator 26 also includes a solenoid valve 104 communicatively coupled to the air regulator 102 and mechanically connected to a source of compressed air (not shown). The air regulator 102 and the solenoid valve 104 are depicted schematically in FIG. 6. The solenoid valve 104 is configured to direct compressed air to the rod end and the blind end of cylinder 98 on a selective basis, based on inputs from the conveying control 68. When the compressed air is directed to the rod end of the cylinder 98, the piston 100 is driven to its first position, thereby positioning the sealing puck 88 in its lower position. When the compressed air is directed to the blind end of the cylinder 98, the piston 100 is driven to its second position, thereby positioning the sealing puck 88 in its upper position.

The air regulator 102 is configured to control the air pressure supplied through the solenoid valve 104 on an analog basis, in response to inputs from the conveying control 68. In particular, during normal operation in which vacuum is being provided to the vacuum receiver 22, the conveying control 68 generates an output that, when received by the air regulator 102, causes the air regulator 102 to de-energize the solenoid valve 104, or to maintain the solenoid valve 104 in a de-energized state, such that compressed air is directed to the rod end of the cylinder 98, which in turn causes the sealing puck 88 to reside in its lower position and block the second opening 78 in the body 72. In this state, vacuum is being pulled from the vacuum receiver 22 by way of the first opening 76 in the body 72, and the air/vacuum line 24.

As noted above, the valve 66 is configured to relieve the vacuum provided to the air/vacuum line 24 (and the vacuum receiver 22) at a set point that can be automatically selected and varied by the conveying control 68. This feature obviates the need for a conventional relief valve having a fixed set point, or a set point that needs to be adjusted mechanically. In particular, the air regulator 102 is further configured to adjust the pressure of the compressed air being supplied to the rod end of the cylinder 98, in response to inputs from the conveying control 68 indicating the desired set point. Because the force with which the sealing puck 88 is being held over the second opening 78 is related to the pressure of the compressed air being supplied to the rod end of the cylinder 98, the air regulator 102, under the direction of the conveying control 68 and through control of the solenoid valve 104 to produce a desired air pressure within the rod end of the cylinder 98, can regulate the vacuum relief set point of the valve 66. In particular, higher air pressure within the rod end of the cylinder 98 causes the actuator 96 to exert a greater downward force on the sealing puck 88. This results in greater resistance of the sealing puck 88 to movement from its lower position, which in turn raises the relief set point. Conversely, lower air pressure within the rod end of the cylinder 98 lessens the resistance of the sealing puck 88 to movement from its lower position, which in turn lowers the set point.

The relief set point, along with the nominal rotational speed of the blower 52, can be adjusted by the conveying control 68 to match the requirements driven by the lower barometric pressure associated with high-elevation locations at which the system 10 may be installed and operated. The local barometric pressure can be provided to the conveying control 68 by a pressure sensor 105 depicted in FIG. 6. The adjustment of the relief set point and the nominal rotational speed of the blower 52 can be performed automatically by the conveying control 68, based on a predetermined relationship between the barometric pressure and the desired values of the relief set point and the nominal rotational speed of the blower 52, with the relationship being stored in the memory of the conveying control 68. As noted above, the ability to vary the relief set point electronically obviates the need for a user to make physical adjustments to vary the set point, as is required in a conventional relief valve.

The conveying control 68, in conjunction with the air regulator 102, can be further configured to vary the relief set point during initial startup of the vacuum generator 26 when the system 10 is being commissioned in a new installation, to tailor the setpoint to the specific performance characteristics of the blower 52.

When the conveying control 68 determines that the vacuum in the air/vacuum line 24 should be broken, for example, during idle operation of the blower 52, the conveying control 68 generates an output that, when received by the air regulator 102, activates the solenoid valve 104 such that the compressed air is directed to the blind end of the cylinder 98. This in turn drives the sealing puck 88 to its upper position so that the first opening 76 is closed and ambient air can enter the valve 66 by way of the secondary inlet 86 and the second opening 78. Thus, the air/vacuum line 24 is isolated from the internal volume 74 of the body 70 and air no longer is being pulled to the blower 52 from the air/vacuum line 24 and the vacuum receiver 22, interrupting the vacuum supplied the vacuum receiver 22 by way of the air/vacuum line 24. Instead, ambient air is pulled into the blower 52 by way of the secondary inlet 86, the second and third openings 78, 80 and the internal volume 74 of the body 70, the outlet fitting 90, the filter housing 62, the air filter 60, and the air/vacuum line 65.

The actuator 96 is described as a double-acting pneumatic actuator for illustrative purposes only. The actuator 96 can have other configurations in alternative embodiments. For example, the actuator 96 can be configured as a single-acting pneumatic actuator.

The vacuum generator 26 further includes a vacuum/pressure sensor 106 communicatively coupled to the conveying control 68 and fluidly coupled to a tap (not shown) in the air/vacuum line 65. The vacuum/pressure sensor 106 thus reads the post-filter vacuum level, i.e., the vacuum level downstream of the air filter 60, between the air filter 60 and the blower 54. The vacuum/pressure sensor 106 is depicted diagrammatically in FIG. 6.

The system 10 can include additional pressure taps, pressure sensors, and/or vibration sensors, with the number of additional pressure taps, pressure sensors, and vibration sensors depending, in part, on the distance between the material source and the vacuum receiver 22. For example, an additional pressure tap and pressure sensor can be positioned at mid-distance in a material/air convey line 20 line of moderate length. As another example, in systems where the resin granulates 12 are supplied from a distribution manifold connected to the material source, additional pressure taps and pressure sensors can placed with the distribution manifold.

In some embodiments, the conveying control 68 can be configured to interpolate the vacuum level at various locations within the system 10 based on vibration data acquired from sensors mounted on the material/air convey line 20, to indicate the operational vacuum levels or the material flow within the system 10.

The conveying control 68 is configured to monitor the operational vacuum level within the vacuum generator 26 based on the post-filter vacuum level. Based on the measured vacuum level at pump idle, i.e., at vacuum break, the conveying control 68 can determine the current status of the air filter 60 and can adjust the performance of the vacuum generator 26, within limits, to maintain the operational status of the system 10 at an optimum level as the air filter 60 becomes saturated. The system 10 is configured to overcome various factors that can cause the pressure or pressure drop to vary. These factors can include filters with material blocking the transmission of gas therethrough, line obstructions, and other factors that cause the pressure drop to vary over a part of the flow path. Also, the conveying control 68 can generate operator alerts, for example, upon detecting the early stages of saturation of the air filter 60. The conveying control 68 can generate an alarm, for example, upon detecting intermediate or later stages of filter saturation.

The conveying control 68 is further configured to track vacuum usage over time based on the post-filter vacuum level obtained from the vacuum/pressure sensor 106. This feature can allow operators to note the time an event occurred, schedule maintenance, or eliminate a failure mechanism in time to avoid damage to the equipment. The tracking of vacuum usage over time can be for the purposes of historical data acquisition, to maintain a before and after view of an event, and/or to provide baseline data. Historical data collection can provide deeper insight into when the various components of the system 10 were in good working order, prior to some type of occurrence that changed the operating characteristics of the system 10, such as separating lines, worn system components, saturated filters, material/air ratio valves that were tampered with, etc. Also, tracking actual vacuum usage can give insight into how the vacuum generator 26 has been treated, and whether the vacuum generator 26 is operating within the desired parameters set at the factory. Vacuum usage also can provide an indication of whether the vacuum generator 26 is under-utilized due to factors such as the material/air feed not being optimized for a particular application.

Also, the conveying control 68 can provide an indication of the pump/vacuum utilization, which can be used to determine the potential for expanding the system 10 to accommodate additional stations.

The conveying control 68 is further configured use the post-filter vacuum-level readings from the vacuum/pressure sensor 106 to make minor adjustments to the performance of the vacuum generator 26, within limits, to accommodate or compliment the particular type material feed being used in the system 10, e.g., carbureted probe/lance, material pickup devices such as the automated material feed depicted in FIG. 1, etc.

The conveying control 68 can generate alerts and/or alarms upon detecting an underloaded condition at which the vacuum generator 26 is operating at a lower than normal vacuum level by several inches of mercury or more; an overloaded condition at which the vacuum generator 26 is reaching the vacuum relief point occasionally and/or is operating over the optimal or design vacuum level; a vacuum leak, which can cover a wide range of vacuum levels from idle operation up to several inches of mercury below the optimal/designed vacuum level; a deadheaded condition where the vacuum generator 26 is operating at its vacuum relief point and is not adequately pulling material or is not pulling any material at all; an empty material source condition, etc., based on the post-filter vacuum level.

The vacuum generator 26 also includes a sensor unit 110 configured to provide information indicating the status of the blower 52. The sensor unit 110 can be mounted, for example, on an outer casing of the blower 52 or the motor 54 as depicted in FIG. 2. The sensor unit 110 includes one or more vibration sensors 112 communicatively coupled to the conveying control 68. The sensor unit 110 also includes a temperature sensor 114. The vibration sensors 112 and the temperature sensor 114 are depicted diagrammatically in FIG. 6. The sensor unit 110 also can include the vacuum/pressure sensor 106.

The vibration sensors 112 are configured to sense vibration of the blower 52 and the motor 54. The conveying control 68 can be configured to determine the oil status and the bearing status of the blower 52 and the motor 54 based on the vibration levels, using techniques as described in one or more of U.S. Pat. Nos. 10,599,982; 10,638,295; 10,598,520; and 11,268,760, the contents of which are incorporated by reference herein in their entirety. The temperature sensor 114 provides an indication of the local temperature.

The conveying control 68 can be configured to recognize a plug or other blockage in the material/air convey line 20 or other location upstream of the blower 52. The conveying control 68 can recognize a plug based on a predetermined increase in the post-filter vacuum level as measured by the vacuum/pressure sensor 106, in conjunction with the detection of a “no load” condition. Upon detecting the plug, the conveying control 68 can temporarily raise the pressure-relief set point of the valve 66 to increase the maximum vacuum level that can be provided to the material/air convey line 20. Once the relief point has been adjusted, the conveying control 68 can command a brief increase in the rotational speed of the motor 54 to subject the downstream side of the plug to an increased vacuum level, i.e., to a more negative pressure, to cause the plug to dislodge. Because an IPM-SynRM motor (and IPMSM/PMSM motors) can be driven significantly above 100 percent of their rated speed for brief periods, the motor 54 is particularly well suited to spiking the vacuum level in this manner to dislodge plugs in the material/air convey line 20. The ability to remove plugs in this manner can eliminate the system downtime caused by the need to break down and clean the material/air convey line 20.

The conveying control 68 can be further configured to provide an air boost to the air filter 60 when the air filter 60 is saturated, to overcome an increase in the pressure drop across the air filter 60 due to the contaminate saturation, thereby maintaining the performance level of the system 10, while informing the operator, through alerts, that replacement of the air filter 60 is soon due.

Once the vacuum receiver 22 (or all the stations in a multi-station system) has had its demand for resin granulates 12 satisfied, the vacuum generator 26 can operate in a cooldown or idle mode for a set period of time, instead of immediately shutting down. Operating the blower 52 at idle for a cooldown period can extend the life of the bearings and other components of the blower 52 and the motor 54. Also, since the various stations in a multi-station system (such as the systems 10a, 10b described below) may come into demand at any time, in the event one of the stations requires additional resin granulates 12 during the cooldown period, the vacuum generator 26 can be brought back to normal operating speed prior to being shut down, potentially avoiding the high-inrush currents, incremental wear, and other detrimental factors that occur during each shut-down and startup cycle.

During the cooldown period, the rotational speed of the blower 52 is reduced to the lowest setting that allows adequate cooling to occur, thereby reducing the amperage draw of the motor 54. Because an IPM-SynRM motor (and IPMSM/PMSM motors), unlike conventional induction motors, can operate efficiently at speeds well below their nominal operating range and can cool faster even though the operating speed is lower in relation that of a conventional induction motor, the vacuum generator 26 can be operated in the cooldown mode with relatively low energy consumption.

The conveying control 68 can be configured to operate the vacuum generator 26 in different performance modes, depending on the specific requirements of a particular application. The performance modes are factory set, but may be adjusted by or at the direction of the user per the requirements of a particular application, provided (preferably) that relatively high security access criteria are satisfied. The performance modes can include fast or full speed; target or normal speed; slow speed; and adaptive/additive or line size reduction (reducer). In all performance modes, the blower 54 can be, but is not required to be driven at full (one-hundred percent) speed for the initial two to three seconds upon loading sequence initiation, to commence movement of the granulated material, e.g., the resin granulates 12, after which the blower speed is adjusted to the level associated with the selected performance mode.

In the case of the adaptive/additive mode, the blower speed is set to a speed tailored to the reduced line size being used in that particular application. As noted above, IPM-SynRM motors (and IPMSM/PMSM motors) can operate efficiently at speeds well below their nominal operating range, and thus are particularly well suited for use with the lower airflows associated with reduced line sizes. By contrast, in systems using conventional induction motors, including systems using induction motors motor operated via a variable frequency drive, the motor typically is operated at its fixed speed or at a speed within its nominal operating range, and the resulting vacuum needs to be partially bled off to accommodate the lower airflow requirements of a reduced line size, resulting in a higher overall energy consumption than would be required if the motor was able to operate efficiently below it nominal operating range.

During purge cycles, the conveying control 68 lowers the rotational speed of the blower 54 in response to the reduced material load in the material/air convey line 20, to help mitigate degradation of the granulated material and the material/air convey line 20.

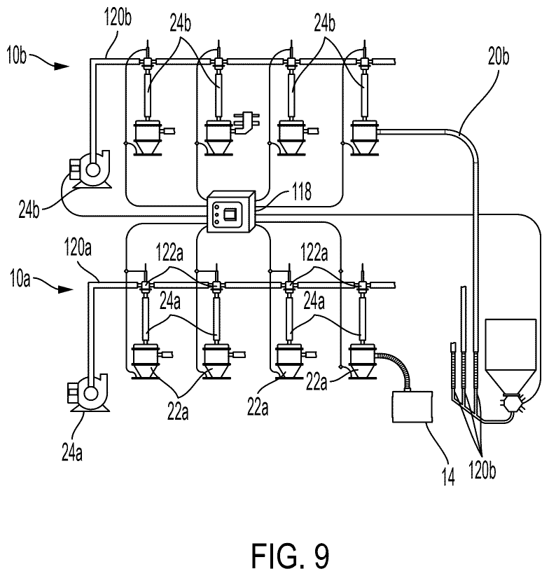

FIG. 9 depicts two multi-station conveying systems controlled by a central conveying controller 118 communicatively coupled to the conveying control 68, as shown in FIG. 6A. In particular, FIG. 9 depicts a first conveying system 10a configured to convey a granulated material, such as the resin granulates 12, a relatively short distance; and a second conveying system 10b configured to convey the resin granulates 12 over a relatively long distance.

The first conveying system 10a includes a plurality of vacuum receivers 22a. The vacuum receivers 22a can be substantially identical to the vacuum receiver 22 of the conveying system 10. Each vacuum receiver 22a is connected to a local material source, such as the surge hopper/bin 14 or a Gaylord container, by an associated material/air convey line 20a (only one of the material/air convey lines 20a is shown in full in FIG. 9, for clarity of illustration).

The first conveying system 10a also includes a vacuum header 120a, and a plurality of vacuum valves 122a. Each vacuum valve 122a is connected to the vacuum header 120a. Each vacuum valve 122a also is connected to an associated one of the vacuum receivers 22a by an associated air/vacuum line 24a. Also, each vacuum valve 122a is communicatively coupled to a central conveying controller 118.

The first conveying system 10a further includes a vacuum generator 26a. The vacuum generator 26a can be substantially identical to the vacuum generator 26 of the system 10, and can include a vacuum relief and break valve 66 and an IPM-SynRM motor 54 as discussed above. The inlet fitting 82 of the vacuum generator 26a is connected to the vacuum header 120a, so that the vacuum generator 26a draws air from the vacuum header 120a, which in turn generates a vacuum within the vacuum header 120a. The first conveying system 10a also can include a dust collection device (not shown) located immediately upstream of the vacuum generator 26a.

Each vacuum receiver 22a is in fluid communication with an associated vacuum valve 122a by way of its associated air/vacuum line 24a, and the vacuum header 120a. When resin granulates 12 are required by a particular vacuum receiver 22a, the central conveying controller 118 sends an output to the vacuum valve 122a associated with that vacuum receiver 22a. The output, when received by the vacuum receiver 22a, causes the vacuum valve 122a to open, which in turn places the interior volume 30 of the vacuum receiver 22a in fluid communication with the vacuum header 120a by way of the associated air/vacuum line 24a. The vacuum within the interior volume 30 causes resin granulates 12 to be drawn from the material source and into the vacuum receiver 22a by way of the material/air convey line 20a associated with that particular vacuum receiver 22a, as discussed above in relation to the system 10. Also, the central conveying controller 118 is communicatively coupled to the vacuum generator 26a and is configured to command the vacuum generator 26a to operate at its pre-set lower nominal speed when there is a demand for resin granulates 12 in one or more of the vacuum receivers 26a.

The second conveying system 10b comprises a vacuum generator 26b, a plurality of vacuum receivers 22b, a vacuum header 120b, and a plurality of vacuum valves 122b, material/air convey lines 20b, and air/vacuum lines 24b each associated with a respective one of the vacuum receivers 22b. The components and component arrangement of the second conveying system 10b are substantially similar to those of the first conveying system 10a, with the exception that the material/air convey lines 20b of conveying system 10b are substantially longer than the material/air convey lines 20a of conveying system 10a, to accommodate the greater conveying distance in the second system 10b. The pump 26b may operate at its nominal speed, or above nominal speed in order to convey the resin granulates 12 over the longer distance. The above description of the system 10a otherwise applies equally to the system 10b.

Details of the first and second conveying systems 10a, 10b are presented for illustrative purposes only. The vacuum generator 26 can be used in multi-station conveying systems having other configurations.

The vacuum generators 26a, 26b can accommodate a mix of long and short conveying distances due to the variability in the performance of the vacuum generators 26a, 26b that can be achieved due to the wide operating range and controllability of the IPM-SynRM motor 54 (or alternatively, an IPMSM or PMSM motor), and the adjustable vacuum operational level range, which in turn can enable the performance of the vacuum generators 26a, 26b to be adjusted based on the specific the requirements of a particular station.

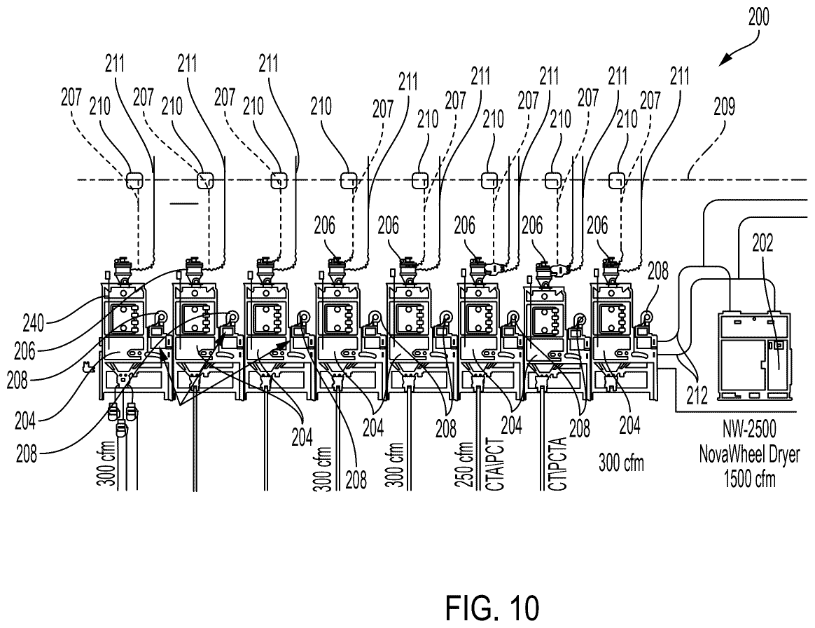

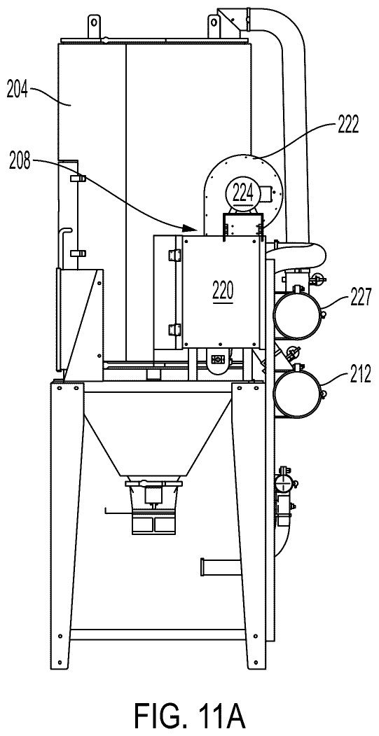

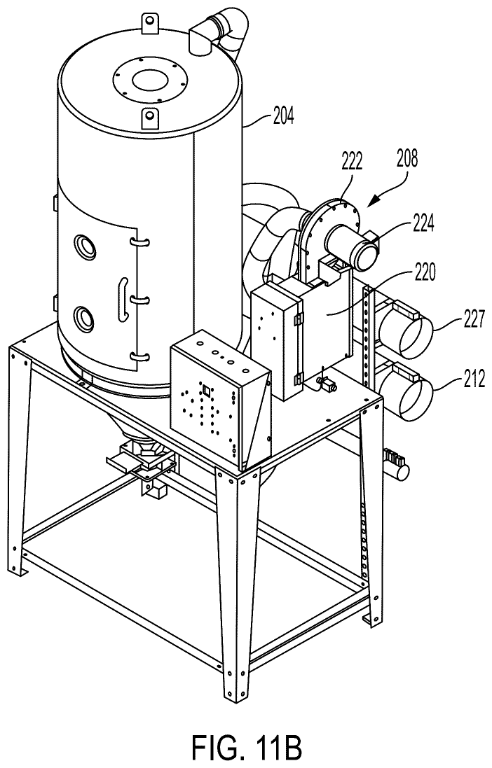

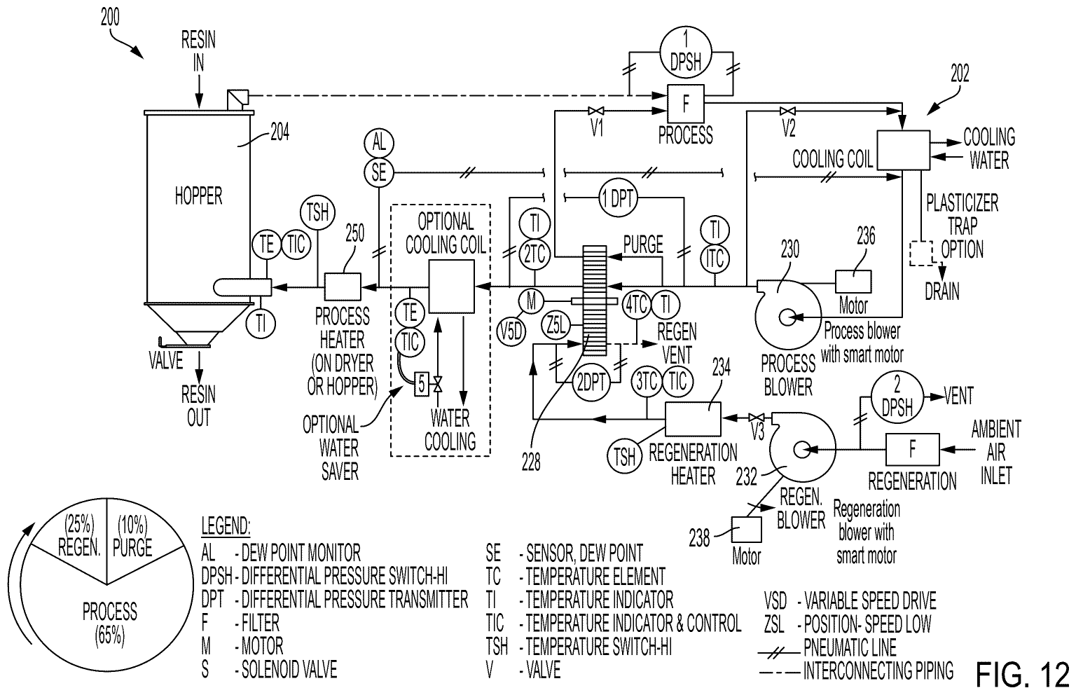

FIG. 10 depicts a multi-station system 200 for drying a granulated material, such as the resin granulates 12 referenced above in relation to the conveying system 10. FIGS. 11A and 11B are close-up views of one station of the system 200. FIG. 12 is a schematic illustration of an alternative embodiment of the drying system 200 in the form of a single-station drying system 200a. Components of the system 200a that are the same as, or substantially similar to components of the system 200 are referred to using common reference characters.

The system 200 comprises a central dryer 202, a plurality of drying hoppers 204, and a plurality of vacuum receivers 206. The system 200 also includes a central drying controller (not shown). The central drying controller is communicatively coupled to the central dryer 202, the drying hoppers 204, and the vacuum receivers 206. Each vacuum receiver 206 is mounted on, and is associated with a corresponding one of the drying hoppers 204. (The vacuum receiver 206 associated with the drying station shown in FIGS. 11A and 11B is not depicted in those figures, for clarity of illustration.) The system 200 also includes a plurality of heater/blower units 208. Each heater/blower unit 208 connected to a corresponding one of the drying hoppers 204, and provides heated process air to its associated drying hopper 204.

Alternative embodiments of the system 200 can be configured without the heater/blower units 208. For example, the single-station system 200a incorporates a process heater 250 in lieu of a heater/blower unit 208. In multi-station systems not equipped with heater/blower units, a centralized heater and booster blower, or a centralized heater and a centralized blower located remotely from the heater can be used to provide heated air to the drying hoppers 204. In such embodiments, a manual or automated valve associated with each individual drying hopper 204 can be used to control the amount of heated air being supplied to each drying hopper 204.

Referring to FIG. 10, each vacuum receiver 206 is connected to a vacuum source (not shown) by way of an associated air/vacuum line 207, a common vacuum header 209, and an associated vacuum valve 210 mounted on the vacuum header 209 and configured to place the vacuum receiver 206 in fluid communication with the vacuum source on a selective basis, as discussed above in relation to the system 10a. Each vacuum valve 210 is communicatively coupled to the central drying controller. The vacuum source can be, for example, a vacuum generator such as, or similar to the vacuum generator 26, equipped with a blower-drive motor such as the motor 54 which, as noted above, can be an IPM-SynRM, IPMSM, or PMSM motor.

Each vacuum receiver 206 also is connected to a material source (not shown) by an associated material/air convey line 211. Each vacuum receiver 206 draws resin granulates 12 from the material source in response to the vacuum produced selectively within the vacuum receiver 206, as discussed above in relation to the system 10. After the vacuum receiver 206 has been loaded and no longer is being subjected to a vacuum, the resin granulates 12 can be provided to the associated drying hopper 204 by opening a gate valve or other suitable device on the vacuum receiver 206, so that the resin granulates 12 can drop into the drying hopper 204 due to gravity.

Each of the heater/blower units 208 is connected to the central dryer 202 by way of a common supply header 212, visible in FIGS. 10-11B, and an associated valve (not shown) that selectively places the heater/blower unit 208 in fluid communication with the supply header 212. When the valve associated with a particular heater/blower unit 208 is open, dry air supplied to the supply header 212 from the central dryer 202 can enter the heater/blower unit 208. (In applications where a centralized blower is used in lieu of the heater/blower units 208, the dry air can be supplied to the supply header 212 from the central dryer 202 via the centralized heater.)

Each heater/blower unit 208 includes a heater 220 and a blower 222, visible in FIGS. 11A and 11B. The heater 220 is configured to heat the air entering the heater/blower unit 208 to a temperature up to, for example, 350° F. The blower 222 distributes the heated air within the drying hopper 204.

The impeller of the blower 222 is driven by a motor 224 of the heater blower unit 208. The drive motor 224 can be an IPM-SynRM motor (or alternatively, an IPMSM or PMSM motor). In applications where a centralized heater and booster blower, or a centralized heater and a remotely-located blower are used in lieu of heater blower units, the drive motors of the booster blower and/or the remote centralized blowers can be IPM-SynRM motors (or alternatively, IPMSM or PMSM motors). These types of motors can provide operational benefits similar to, and in addition to those discussed above in relation to the conveying system 10, e.g., higher power density, instantaneous torque output, high overall efficiency, and the ability to operate efficiently well above and below its nominal range of operating speeds. Thus, the IPM-SynRM/IPMSM/PMSM motor can facilitate increases in airflow and modification of the pressure of the process air to accommodate larger hoppers, or to function as air distribution means. In addition, the use of these types of motors can increase the amount of moisture that can be vaporized or removed from the resin granulates 12 above the level that typically would be possible in systems incorporating conventional inductive motors. Thus, the resin granulates 12 can be heated in less time and production can be implemented more quickly, thereby reducing the start-up time of the systems 200, 200a.

The central dryer 202 is configured to provide dry, e.g., −40° F. dew point, air, or air having another dew point as required for a particular application. The central dryer 202 can be, for example, a desiccant-wheel dryer. The central dryer 202, which is also incorporated into the system 200a, is depicted in detail in FIG. 12. The central dryer 202 comprises a rotor or wheel 228 having a desiccant material impregnated therein; a first, or process blower 230; a second, or regeneration blower 232; and a heater 234. The impeller of the process blower 230 is driven by a first drive motor 236. The impeller of the regeneration blower 232 is driven by a second drive motor 238. The use of a desiccant-wheel dryer as the central dryer 202 is disclosed for illustrative purposes only. Other types of dryers, such as membrane dryers, dual-bed dryers, carousel dryers, etc., can be used in lieu of a desiccant-wheel dryer.

The process blower 230 draws heated, moisture-laden process air, from one or more of the drying hoppers 204, through a first portion of the wheel 228, so that the desiccant absorbs moisture from the process air. The dried process air then is recirculated to the dry-air header 212, where the process air is selectively directed to the heater/bower units 208 of the individual drying hoppers 204 as discussed above. In the single-station system 200a, the dried process air can be directed to the process heater 250, which heats the process air before the process air is recirculated to the drying hopper 204. In multi-station systems that are not equipped with heater/blower units 208, the dried process air can be directed to and heated by the centralized heater before being selectively directed to the individual drying hoppers 204.

The regeneration blower 232 draws ambient air through the heater 234, and through a second portion of the desiccant wheel 228. The heated air regenerates the desiccant by absorbing the moisture previously absorbed by the desiccant from the process air. The regeneration air, now laden with moisture, can be discharged to the ambient environment, or can be used as a means to preheat a secondary air steam or to collect moisture through condensation.

The first and second drive motors 236, 238 can be IPM-SynRM motors (or alternatively, IPMSM or PMSM motors), which can provide operational benefits similar to, and in addition to those discussed above in relation to the conveying system 10. For example, the use of an IPM-SynRM/IPMSM/PMSM motor as the first drive motor 236 of the process blower 230 can facilitate increases in impeller speed and airflow when the first drive motor 236 is operated with 50-Hz a power supply, thus allowing the first drive motor 236 to compensate for the reduced speed of the impeller due to the 50-Hz power supply and returning the performance of the process blower 230 a level equivalent to achieved with a 60-Hz power supply. Also, the first drive motor 236 can increase the impeller speed up to its operational maximum to compensate for dirty filters, higher-than-typical moisture levels, high return air/operating temperatures, etc. The above benefits be achieved in both multi-station dying systems such as the system 200, and single-station dying systems such as the system 200a.

Also, in most cases, not all of the drying hoppers 204 in a muti-station system such as the system 200 are being used at the same time, and some of the drying hoppers 204 may only be operating in a pre-heating or pre-drying mode. The speed variation capability and the controllability of the IPM-SynRM/IPMSM/PMSM motors allow the airflow rate and power consumption of the process blower 230 to be varied in direct relationship to the heat and airflow levels required by the system 200 at a given time.

The use of an IPM-SynRM/IPMSM/PMSM motor as the second drive motor 238 of the regeneration blower 232 can facilitate substantial increases and decreases in airflow from the regeneration blower 232 to well over 100 percent and down to practically zero in relation to nominal airflow, in contrast to the relatively limited airflow variation of about 60 percent to about 100 percent available with a conventional induction motor. This can allow the systems 200, 200a to compensate for and overcome pressure drop issues, and can extend the range of granulate moisture levels that can be handled by the systems 200, 200a. Also, IPM-SynRM/IPMSM/PMSM motors, when operated at a low-speed or partial load condition, do not adversely affect the power factor of the facility in which the motor is located, in contrast to an induction motor.

Each drying hopper 204 can be equipped with a probe 240 communicatively coupled to the central drying controller and configured to sense the moisture level of the resin granulates 12 at various levels within the drying hopper 204, as described U.S. patent application Ser. No. 18/432,831, the contents of which are incorporated by reference herein in their entirety.

When a particular vacuum receiver 206 requires resin granulates 12, the central drying controller can generate an output that causes the vacuum source, e.g., the vacuum generator 26, to activate (or to remain activated). The central drying controller also generates an output that causes a corresponding valve 210 in the vacuum header 209 to open so that the vacuum receiver 206 is subject to a vacuum that draws the resin granulates 12 from the material source and to the vacuum receiver 206 by way of the associated material/air convey line 211. After the resin granulates 12 have been transferred to the vacuum receiver 206 and the vacuum valve 210 has been closed, the central drying controller can generate another output that causes the gate valve or other device at the exit of the vacuum receiver 207 to open so that the resin granulates 12 can drop into the drying hopper 204.

To commence the drying process in a particular drying hopper 204 once the drying hopper 204 has been loaded with resin granulates 12, the central drying controller can generate an output that causes the heater/blower unit 208 associated with that drying hopper 204 to activate. The central drying controller can generate another output that causes the associated valve in the supply header to 212 to open, placing the heater/blower unit 208 in fluid communication with the central dryer 202 and allowing the dried process air from the central dryer 202 to enter the heater/blower unit 208.

The dried process air, after being heated by the heater/blower unit 208, is forced into the interior of the drying hopper 204 by the blower 222 of the heater/blower unit 208, at or near the bottom of the drying hopper 204. The process air flows upwardly within the drying hopper 204, contacting the resin granulates 12 and removing moisture from the resin granulates 12. The moisture-laden process air exits the drying hopper 204 at or near the top of the drying hopper 204, and returns to the central dryer 202 by way of a return header 227 visible in FIGS. 11A and 11B. The central dryer 202 removes the moisture from the process air as discussed above, and the process air can be recirculated to the same, or another drying hopper 204.

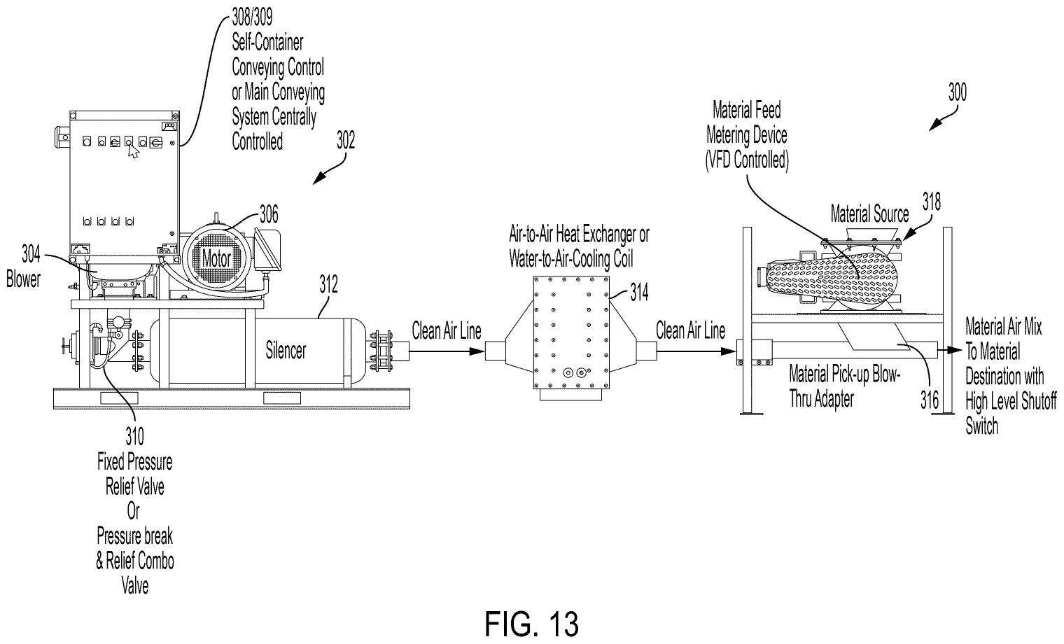

FIG. 13 depicts a pressure conveying system 300. The system 300 comprises a pump unit 302 comprising a blower 304, and a motor 306 coupled to an impeller of the blower 304 and configured to drive the impeller in rotation. The impeller is configured to pressurize the air passing through the blower 304. The motor 306 can be an IPM-SynRM motor. In alternative embodiments, the motor 54 can be an IPMSM motor or a PMSM motor.

The pump unit 302 also comprises a conveying control 308 communicatively coupled to the motor 306 and configured to control the operation of the motor 306. In multi-station conveying systems, the conveying control 308 can be used in conjunction with central conveying controller 309 as discussed above in relation to the vacuum conveying system 10a.

The pump unit 302 also includes a combination pressure relief and break valve 310. The valve 310 is in fluid communication with the exit port of the blower 304, and thus receives the pressurized process air generated by the blower 304. The valve 310 has a structure similar to that of the combination relief and break valve 66 of the vacuum conveying system 10, and like reference characters are used herein to refer to similar or identical components of the valve 310 and the valve 66. The valve 310 can function in a manner similar to the valve 66 to relieve or break the pressure supplied to the system 300 by the pump unit 302, with the following exception. When the conveying control 308 determines that the positive pressure of the airflow within the system 302 should be relieved or broken because the pressure has reached the set point or because the blower 52 is to be operated at an idle condition, the conveying control 308 generates an output that, when received by the air regulator 102, activates the solenoid valve 104 such that the compressed air is directed to the blind end of the cylinder 98 at a sufficient pressure to overcome the pressurized airflow acting against the sealing member 88, so that the sealing member 88 is driven to its upper position whereby the first opening 76 is closed and the pressurized air can exit the valve 66 to the ambient environment by way of the second opening 78 and the secondary inlet 86. Thus, the lines and other components located downstream of the of the first opening 76 are isolated from the internal volume 74 of the body 70 and from the pressurized airflow being produced by the blower 52.

In alternative embodiments of the system 300, a fixed pressure relief valve can be used in lieu of the valve 310.

The pump unit 302 further includes a silencer 312 in fluid communication with the exit of the combination pressure relief and break valve 310. After passing through the silencer 312, the pressurized process air is directed to a cooling unit 314, which removes some or all of the heat of compression that was imparted to the process air by the blower 304. The cooling unit 314 can be, for example, an air-to-air heat exchanger or a water-to-air cooling coil.

After passing through the cooling unit 314, the pressurized process air can be directed to a material pick-up device 316 of the system 300. The material pick-up device 316 can be, for example, a material pick-up blow-through adapter that causes the material to be conveyed, e.g., resin granulates 12, to be entrained in the pressurized airflow. The material entering the pressurized airflow can be metered by a material feed metering device 318 of the system 300. The material suspended in the pressurized airflow can be conveyed to one or more material destinations such as storage bins or process devices.

The system 300 can be configured with sensors in a manner similar to the vacuum-conveying system 10. The conveying control 308 can control the operation of the blower 304, the combination pressure relief and break valve 310, and the remainder of the system 300 in a manner similar to the conveying control 68 of the vacuum-conveying system 10.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

We claim:

1. A system for conveying a granulated material from at least one material source, comprising:
at least one receiver in fluid communication with the material source; and
at least one vacuum generator or pump unit comprising a blower configured to generate a vacuum or a pressurized airflow, a motor, and a control unit communicatively coupled to the motor, wherein:
the blower is in fluid communication with the receiver;
the blower comprises a housing, and an impeller mounted in the housing and configured to rotate in relation to the housing;
the motor is connected to the blower and is configured to generate a torque that drives the impeller in rotation;
the motor is one of an IPM-SynRM motor, an IPMSM motor, and a PMSM motor; and
the control unit is configured to control the speed of the motor based on inputs from one of more sensors of the system.

2. A system for conveying a granulated material from at least one material source, comprising:
at least one receiver in fluid communication with the material source; and
at least one vacuum generator or pump unit comprising a blower configured to generate a vacuum or a pressurized airflow, a combination relief and break valve in fluid communication with the blower, and a control unit communicatively coupled to the combination relief and break valve, wherein:
the blower is in fluid communication with the receiver on a selective basis so that an interior volume of the receiver is subjected to the vacuum or the pressurized airflow and the granulated material is transported to the interior volume of the receiver from the material source in response to the vacuum or the pressurized airflow,
the combination relief and break valve is configured to interrupt the vacuum or the pressurized airflow provided to the interior volume of the receiver when a vacuum level or a pressure level of the pressurized airflow reaches a relief set point, and
the control unit is configured to adjust the relief set point based on one or more predetermined criteria.

3. The system of claim 2, wherein:
the blower comprises a housing, and an impeller mounted in the housing and configured to rotate in relation to the housing; and
the vacuum generator or the pump unit further comprises a motor connected to the blower and configured to generate a torque that drives the impeller in rotation.

4. The system of claim 2, wherein the motor is one of an IPM-SynRM motor, an IPMSM motor, and a PMSM motor.

5. The system of claim 2, wherein the one or more predetermined criteria include a local barometric pressure.

6. The system of claim 5, wherein the control unit is further configured to alter the relief set point based on a pre-determined relationship between a desired relief set point and the local barometric pressure.

7. The system of claim 3, wherein the control unit is further configured to increase or decrease the relief set point and increase or decrease a rotational speed of the impeller in response to a change in a vacuum level or a positive pressure level in a material flow path between the material source and the vacuum receiver or the pump unit.

8. The system of claim 2, wherein:
the control unit comprises a processor, a memory communicatively coupled to the processor, and computer-executable instructions stored on the memory; and
the processor, upon executing the computer-executable instructions, is configured to cause the relief set point to change based on the one or more predetermined criteria.

9. The system of claim 2, wherein the combination relief and break valve comprises:
a housing defining: an interior passage in fluid communication with the blower, a first opening adjoining the interior passage and being in fluid communication with the receiver on a selective basis, and a second opening adjoining the interior passage and being in fluid communication with the ambient environment on a selective basis; and
a sealing member configured to move between a first position at which the sealing member closes the second opening, and a second position at which the sealing member closes the first opening.

10. The system of claim 9, wherein the combination relief and break valve further comprises an actuator configured to move the sealing member between the first and second positions.

11. The system of claim 9, wherein the actuator, in response to an input from the control unit, is configured to vary a force with which the sealing member is held in the first position of the sealing member to vary the relief set point.

12. The system of claim 11, wherein the actuator comprises:
a cylinder;
a piston disposed within the cylinder and connected to the sealing member, the piston being configured to move within the cylinder between a first position at which the piston constrains the sealing member in the first position of the sealing member, and a second position at which the piston constrains the sealing member in the second position of the sealing member;
a solenoid valve configured to direct compressed air to the first and second sides of the piston on a selective basis; and
an air regulator coupled to the solenoid valve and communicatively coupled to the control unit, the air regulator being configured to cause the solenoid valve to direct compressed air to the first side of the piston to maintain the piston in the first position of the piston and thereby allow the vacuum be transmitted to the receiver by way of the first opening in the housing.

13. The system of claim 12, wherein the relief set point is proportional to the air pressure on the first side of the piston.

14. The system of claim 12, wherein the control unit is further configured to generate an output that, when received by the combination relief and break valve, causes the sealing member to move to and remain in the second position of the sealing member when the blower is operated at an idle condition.

15. The system of claim 10, wherein the actuator comprises:
a cylinder;
a piston disposed within the cylinder and connected to the sealing member, the piston being configured to move within the cylinder between a first position at which the piston constrains the sealing member in the first position of the sealing member, and a second position at which the piston constrains the sealing member in the second position of the sealing member;
a solenoid valve configured to direct compressed air to the first and second sides of the piston on a selective basis; and
an air regulator coupled to the solenoid valve and communicatively coupled to the control unit, the air regulator being configured to cause the solenoid valve to direct compressed air to the second side of the piston to cause the sealing member to move to and remain in the second position of the sealing member when the pressure level of the pressurized airflow reaches the relief set point or when the blower is operated at an idle condition.

16. The system of claim 3, further comprising a direct drive jaw hub connection coupled to the motor and the blower and configured to transfer the torque between the motor and the blower.

17. The system of claim 1, further comprising a pressure sensor communicatively coupled to the control unit and configured to sense a vacuum level or a positive pressure level within the combination relief and break valve upstream of the blower.

18. The system of claim 17, wherein the control unit is further configured to adjust the performance of the vacuum generator or the pump unit based on the type of material feed used to provide the granulated material to the system, and the vacuum level or the positive pressure level within the combination relief and break valve upstream or downstream of the blower.

19. The system of claim 17, wherein the control unit is further configured to generate an alert and/or an alarm upon detecting one or more of an underloaded condition, an overloaded condition, a vacuum leak, a deadheaded condition, and an empty material source condition based on the vacuum level or the positive pressure level within the combination relief and break valve upstream or downstream of the blower.

20. The system of claim 3, further comprising one or more vibration sensors communicatively coupled to the control unit and configured to sense vibration levels in the blower and the motor, wherein the control unit is further configured to determine a status of the oil and a status of one or more bearings of the blower and/or the motor based on the vibration levels.

21. The system of claim 2, wherein the control unit is further configured to cause the blower to operate at a full speed; a normal speed less than the full speed; a slow speed less than the normal speed; and a speed adapted to a particular line size between the material source and the vacuum receiver or the pump unit.

22. The system of claim 2, wherein the granulated material is one or more of plastic resin granulates, an agricultural grain, a food product or food ingredient, and a chemical product or chemical ingredient.

23. The system of claim 2, wherein the vacuum generator or the pump unit further comprises a filter configured to filter the air passing through the vacuum generator or the pump unit, and the control unit is further configured to increase a speed of the motor in response to an increase in a pressure drop across the filter to clear the filter.

24. A system for conveying a granulated material from at least one material source to a receiving area, comprising:
at least one vacuum generator in fluid communication with the receiving area and comprising a blower configured to generate a vacuum, and a control unit, wherein:
the blower comprises a housing, and an impeller mounted in the housing and configured to rotate in relation to the housing, and
a motor connected to the blower and communicatively coupled to the control unit, the motor being configured to drive the impeller in rotation, the motor being one of an IPM-SynRM motor, an IPMSM motor, and a PMSM motor; and
the control unit is configured to adjust operational parameters of the system in real-time to optimize energy usage and performance of the system.

25. The system of claim 24, wherein the granulated material is one or more of plastic resin granulates, an agricultural grain, a food product or food ingredient, and a chemical product or chemical ingredient.

26. A system for conveying a granulated material from at least one material source to a receiving area, comprising:
at least one pump unit in fluid communication with the receiving area and comprising: a blower configured to generate a pressurized airflow, a motor, and a control unit communicatively coupled to the blower, wherein:
the blower comprises a housing, and an impeller mounted in the housing and configured to rotate in relation to the housing;
the motor is coupled to the impeller and is configured to drive the impeller in rotation, the motor being one of an IPM-SynRM motor, an IPMSM motor, and a PMSM motor; and
the control unit is configured to control the speed of the motor based on inputs from one of more sensors of the system; and
a material pick-up device in fluid communication with the blower and configured to introduce the granulated material into the pressurized airflow.

27. The system of clam 26, further comprising a material feed metering device configured to meter the granulated material into the pressurized airflow.

28. A system for conveying a granulated material from at least one material source, comprising:
at least one receiver in fluid communication with the material source; and
at least one vacuum generator or pump unit comprising a blower configured to generate a vacuum or a pressurized airflow, a combination relief and break valve in fluid communication with the blower, and a control unit communicatively coupled to the combination relief and break valve, wherein:
the blower is in fluid communication with the receiver on a selective basis so that an interior volume of the receiver is subjected to the vacuum or the pressurized airflow and the granulated material is transported to the interior volume of the receiver from the material source in response to the vacuum or the pressurized airflow,
the combination relief and break valve is configured to interrupt the vacuum or the pressurized airflow provided to the interior volume of the receiver when a vacuum level or a pressure level of the pressurized airflow reaches a relief set point, and
the control unit is configured to: adjust the relief set point based on one or more predetermined criteria to prevent and excessive vacuum or and excessive positive pressure within the system; and to vary a rotational speed of the blower to adjust the vacuum level or the positive pressure of the pressurized airflow within the system.

29. The system of claim 28, wherein the control unit is further configured to vary the rotational speed of the blower to finely adjust the vacuum level or the positive pressure of the pressurized airflow within the system.
